(19) United States
(12) Patent Application Publication
(10) Pub. No.: US 2018/0321522 A1
(43) Pub. Date: Nov. 8, 2018

(54) SUCTION APPARATUS AND DETECTING SYSTEM

(71) Applicants: BOE TECHNOLOGY GROUP CO., LTD., Beijing (CN); BEIJING BOE DISPLAY TECHNOLOGY CO., LTD., Beijing (CN)

(72) Inventors: Kangning YIN, Beijing (CN); Dongyang FENG, Beijing (CN); Xiaofei SUN, Beijing (CN); Xiaolong JIN, Beijing (CN); Pengfei FENG, Beijing (CN)

(21) Appl. No.: 15/756,157

(22) PCT Filed: Jul. 18, 2017
(86) PCT No.: PCT/CN2017/093316

§ 371 Date: Feb. 28, 2018

(30) Foreign Application Priority Data
Jul. 22, 2016 (CN) 201620783446.0

(51) Int. Cl. G02F 1/13; G05D 16/20

(52) U.S. Cl. CPC G02F 1/1309; G05D 16/2066

(57) ABSTRACT

The present disclosure provides a suction apparatus comprising: a vacuum pump; a suction pipe connected to the vacuum pump at one end; a pressure detecting device disposed on the suction pipe and configured to detect a pressure value within the suction pipe; a controller with a first threshold that receives the pressure value detected by the pressure detecting device and controls the vacuum pump according to a result obtained by comparing the pressure value with the first threshold; and a housing within which the vacuum pump, the controller and the pressure detecting device are located. The first threshold may be set up according to the size of the display panel so that the suction apparatus is adaptable for gravity Mura reliability detections of display panels having different sizes and types.

### CROSS-REFERENCE TO RELATED APPLICATION

This application claims the priority of Chinese Patent Application No. 201620783446.0 submitted to the Chinese Intellectual Property Office on Jul. 22, 2016, the disclosure of which is incorporated herein in its entirety by reference.

### TECHNICAL FIELD

The present disclosure relates to the technical field of display technology, and particularly relates to a suction apparatus and a detecting system.

### BACKGROUND OF THE INVENTION

In order to obtain reliable and safe TFT-LCD (Thin Film Transistor-Liquid Crystal Display) of good quality, LCD panels must undergo a series of reliability detections before delivery. Gravity Mura defect refers to a case where the amount of liquid crystal within the LCD panel is greater, and under an action of gravity, the liquid crystal accumulates at the bottom of the LCD panel, causing the cell gap at the bottom to become greater so that the display on the LCD panel becomes uneven. Due to a slow flow of the liquid crystal and process fluctuations of the liquid crystal amount in the display panel, the LCD panel has a risk of gravity Mura defect. Therefore, the detection of gravity Mura reliability is especially important.

### SUMMARY

The present disclosure has been accomplished in order to at least partially solve the problems in the prior art. The present disclosure provides a suction apparatus and a detecting system that can detect gravity Mura reliability of display panels having different sizes.

According to one aspect of the disclosure, there is provided a suction apparatus comprising:

a vacuum pump;

a suction pipe connected to the vacuum pump at one end;

a pressure detecting device disposed on the suction pipe and configured to detect a pressure value within the suction pipe;

a controller with a first threshold that receives the pressure value detected by the pressure detecting device and controls the vacuum pump according to a result obtained by comparing the pressure value with the first threshold; and

a housing within which the vacuum pump, the controller and the pressure detecting device are located.

The suction apparatus may further comprises a first threshold adjuster provided on the housing and connected to the controller to adjust the first threshold.

The controller may maintain the pressure value within the suction pipe at the first threshold for a cycle time from the vacuum pump is shut down.

The suction apparatus may further comprises a duration adjuster provided on the housing and connected to the controller to adjust the cycle time.

The suction apparatus may further comprises a display device disposed on the housing and configured to display a remaining time that indicates a duration time to maintain the pressure value within the suction pipe at the first threshold.

The suction apparatus may further comprises an alarm device provided on the housing and connected to the controller to alarm when the controller determines that the pressure value is greater or smaller than the first threshold within the cycle time.

The first threshold may be in a range of about 42 to 48 KPa.

The cycle time may be in a range of about 1 to 5 seconds.

The suction pipe may have a diameter of about 6 to 10 mm.

The vacuum pump may be a micro air pump.

According to another aspect of the disclosure, there is provided a detecting system comprising the above mentioned suction apparatus.

The detecting system may further comprises a carrying device configured to carry a display panel, wherein the suction pipe contacts the display panel at the other end so that the suction apparatus sucks the display panel.

The carrying device may include a fixing device configured to fix the display panel onto the carrying device.

### BRIEF DESCRIPTION OF THE FIGURES

FIG. 1 is an external structural schematic view showing the suction apparatus according to an exemplary embodiment of the disclosure;

FIG. 2a is an internal structural schematic view showing the suction apparatus according to an exemplary embodiment of the disclosure;

FIG. 2b is a schematic view showing local connections among a vacuum pump, a suction pipe and a pressure detecting device according to an exemplary embodiment of the disclosure; and

FIG. 3 is a structural schematic view showing a detecting system according to an exemplary embodiment of the disclosure.

### DETAILED DESCRIPTION

To improve understanding of the present disclosure for those skilled in the art, the suction apparatus and detecting system provided in the disclosure will be described below in detail in conjunction with the accompanying drawings.

In the existing art, the gravity Mura reliability detection process includes: firstly, placing an LCD panel vertically for two hours at a high temperature (55° C.), then performing vacuum suction to the LCD panel with a suction apparatus and observing evenness in display of the LCD panel. However, since the produced suction pressure cannot be controlled precisely, the current suction apparatus cannot be used for gravity Mura reliability detections of display panels having different sizes.

In order to at least partially solve the problems in the prior art, the present disclosure provides a suction apparatus and a detecting system.

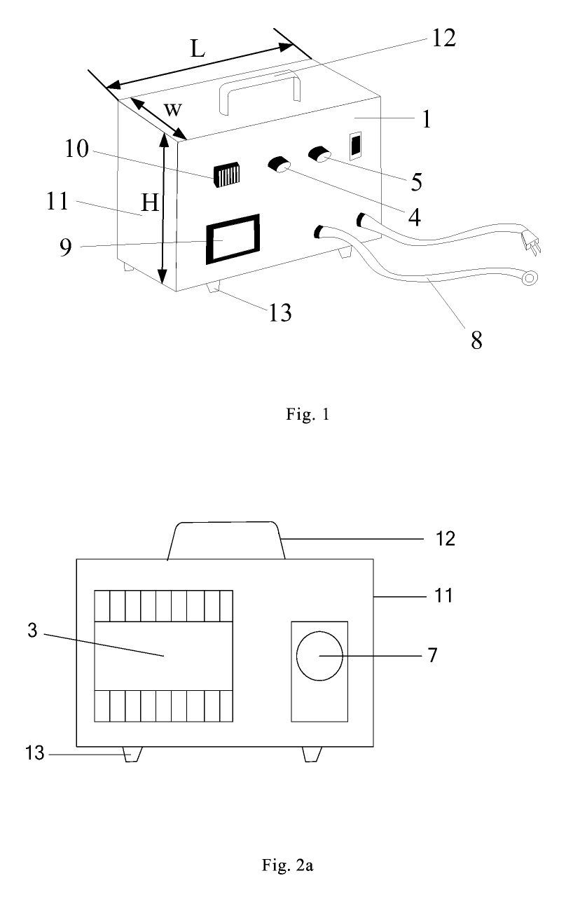

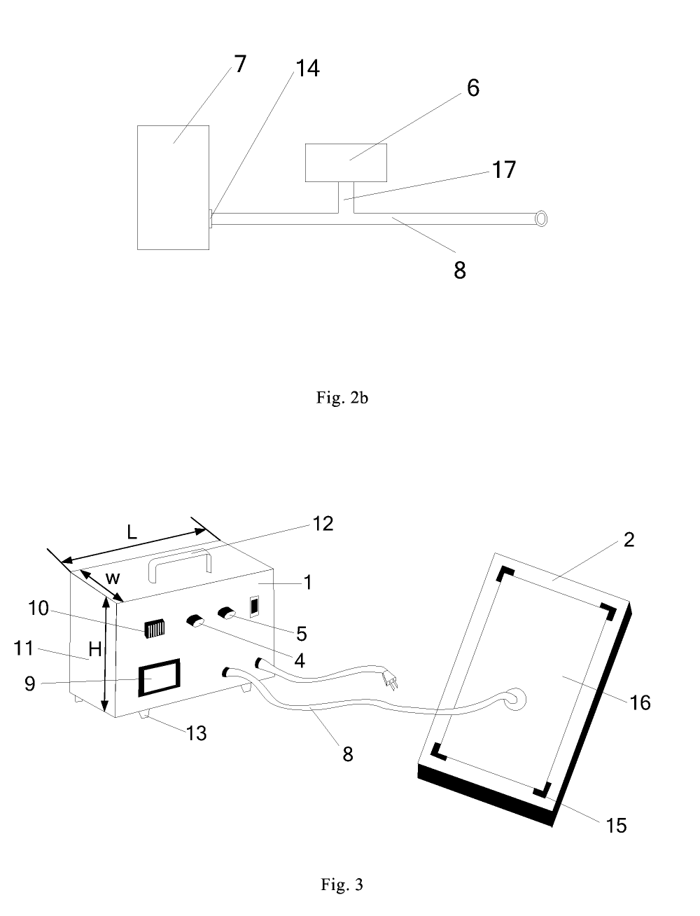

According to one aspect, the present disclosure provides a suction apparatus that can detect gravity Mura reliability of display panels having different sizes. As shown in FIGS. 1, 2a and 2b, a suction apparatus 1 includes a vacuum pump 7 and a suction pipe 8 connected to the vacuum pump 7 at one end. The suction apparatus 1 further includes a pressure detecting device 6 provided on the suction pipe 8 and a controller 3. Specifically, the pressure detecting device 6 is connected to the suction pipe 8 via a connecting pipe 17 so as to detect a pressure value within the suction pipe 8 and send the pressure value to the controller 3.

It should be noted that since the pressure detecting device 6 is located behind the vacuum pump 7, it is not shown in FIG. 2a, but the positional relationship of the pressure detecting device 6 and the vacuum pump 7 is shown in FIG. 2b. As shown in FIG. 2b, the suction pipe 8 is connected to a suction hole 14 of the vacuum pump 7. When started, the vacuum pump 7 vacuumizes the suction pipe 8 via the suction hole 14 so that the suction pipe 8 is vacuum inside.

The controller 3 has a first threshold set therein, which conforms to a size of the display panel.

The controller 3 compares a detected pressure value within the suction pipe 8 with the first threshold. If the detected pressure value equals to the first threshold, the controller 3 controls to shut down the vacuum pump 7 so that the pressure value within the suction pipe 8 is maintained at the first threshold. Thus, the pressure value within the suction pipe 8 is controllable. By providing a corresponding first threshold for display panels of different sizes and types, the suction apparatus 1 may be adaptable for gravity Mura reliability detections of display panels having different sizes.

As shown in FIGS. 1 and 2a, the suction apparatus 1 further includes a housing 11, a handle 12 and an anchor 13, and the vacuum pump 7, the controller 3 and the pressure detecting device 6 are located within the housing 11. The handle 12 is provided atop the housing 11 so as to be grasped by a user when the suction apparatus 1 is moved. The anchor 13 is provided below the housing 11 so that the suction apparatus 1 is kept level. The housing 11 may protect the vacuum pump 7, the controller 3 and the pressure detecting device 6 so that they are isolated from outside interferences. Further, the housing 11 makes it easier to move and carry the suction apparatus 1.

In an exemplary embodiment according to the disclosure, the housing 11 has a cuboid shape, a length L of about 290 mm, a width W of about 130 mm, and a height H of about 150 mm

As shown in FIGS. 1 and 2a, the suction apparatus 1 may further includes a first threshold adjuster 4 that is easy to operate and use. The first threshold adjuster 4 is provided on the housing 11 and connected to the controller 3 to adjust the first threshold provided in the controller 3. The first threshold adjuster 4 may be a rotating knob or button, through which the magnitude of the first threshold may be adjusted so that the user may set up the first threshold manually as needed and thus the suction apparatus 1 may be adaptable for gravity Mura reliability detections of display panels having different sizes and types.

In the exemplary embodiment according to the disclosure, as shown in FIGS. 1 and 2a, the controller 3 also has a cycle time set therein, which may be set up according to the size of the display panel.

The controller 3 is further used to maintain the pressure value within the suction pipe 8 at the first threshold for a cycle time, i.e., maintaining the pressure value within the suction pipe 8 at the first threshold for a cycle time from the vacuum pump 7 is shut down. That is, when the pressure value within the suction pipe 8 equals to the first threshold, the controller 3 starts time keeping, and when the cycle time is reached, the controller 3 controls the vacuum pump 7 to break the vacuum so that the pressure value within the suction pipe 8 drops.

By providing the cycle time within the controller 3 and maintaining the pressure value within the suction pipe 8 at the first threshold for the cycle time, automatic control of the suction time is realized and, compared with manual control, the time is controlled more precisely, thus improving reliability of the gravity Mura reliability detection.

In the exemplary embodiment according to the disclosure, the suction apparatus 1 may further includes a duration adjuster 5 that is easy to operate and use. The duration adjuster 5 is provided on the housing 11 and connected to the controller 3 to set up a cycle time in the controller 3. The duration adjuster 5 may be a rotating knob or button, through which the length of the cycle time may be adjusted so that the user may set up the cycle time manually as needed and thus the suction apparatus 1 may be adaptable for gravity Mura reliability detections of display panels having different sizes and types.

In the exemplary embodiment according to the disclosure, the suction apparatus 1 further includes a display device 9 disposed on the housing 11 for displaying a remaining time that indicates a duration time to maintain the pressure value within the suction pipe 8 at the first threshold. That is, the remaining time equals to the cycle time subtracts a time that has passed since the pressure value starts to be maintained at the first threshold. The remaining time may be obtained by, for example, a time counter or a timing device within the controller.

The display device 9 may be a liquid crystal display to display the duration time to maintain at the first threshold clearly and visually so that the user may learn a progress of the gravity Mura reliability detection.

In the exemplary embodiment according to the disclosure, the suction apparatus 1 may further includes an alarm device 10 provided on the housing 11 and connected to the controller 3. The alarm device 10 is used for alarming when the controller 3 determines that the pressure value within the suction pipe 8 is greater or smaller than the first threshold. The alarm device 10 may be a buzzer and/or an indication lamp.

It should be noted that, within the cycle time, if the pressure value within the suction pipe 8 is greater or smaller than the first threshold, it means the vacuum pump 7 fails to maintain a vacuum state currently, and the controller 3 indicates the alarm device 10 to alarm.

In the exemplary embodiment according to the disclosure, the first threshold adjuster 4, the duration adjuster 5, the display device 9 and the alarm device 10 may be provided at the same side of the housing 11 so that the user may set up parameters and conduct real time observation conveniently.

In the exemplary embodiment according to the disclosure, the suction pipe 8 has a diameter of 6-10 mm so that the apparatus for detecting gravity Mura defects according to the disclosure, compared with those current devices, can detect gravity Mura defects of LCD display modules having smaller sizes.

In the exemplary embodiment according to the disclosure, the vacuum pump 7 is a micro air pump. Micro air pump has the benefits of: (I) needing no vacuum pump oil or lubricating oil within the pump, having no pollution to working media and requiring no maintenance; (II) capable of working 24 hours a day continuously; (III) having smaller volume and noises; and (IV) realizing air suction and inflation.

It should be noted that the suction apparatus 1 further includes a power supply module that includes, for example, a transformer for enabling the suction apparatus 1 to operate under a voltage of 24 V.

It should be noted that the suction apparatus 1 provided in the disclosure is not limited to being applied to the gravity Mura reliability detections of display panels, but can also be applied to occasions such as gas sampling, gas cycle, accelerated filtration and automobile vacuum booster.

The suction apparatus of the disclosure detects the pressure value within the suction pipe by the pressure detecting device, and compares the pressure value with the first threshold by the controller so that the vacuum pump is shut down when the pressure value equals to the first threshold. Thus, the pressure value within the suction pipe is maintained at the first threshold and the pressure value within the suction pipe is controllable. Since the first threshold may be set up according to the size of the display panel, the suction apparatus of the disclosure is adaptable for gravity Mura reliability detections of display panels having different sizes and types.

In another aspect, the disclosure provides a detecting system. As shown in FIG. 3, the detecting system includes a carrying device 2 and the above mentioned suction apparatus 1. The carrying device 2 is configured to carry a display panel 16. The suction pipe 8 is connected to the suction hole 14 of the vacuum pump 7 at one end and contacts the display panel 16 carried on the carrying device 2 at the other end so that the suction apparatus 1 may suck the display panel 16.

The carrying device 2 includes a fixing device 15 configured to fix the display panel 16 onto the carrying device 2 according to the size and/or shape of the display panel 16.

In order to clarify the disclosure, the detecting system of the disclosure will now be described in detail regarding the gravity Mura reliability detection process of a 9.6 inch display panel. The gravity Mura reliability detection process includes the following steps:

at step S1, placing the display panel 16 onto the carrying device 2, and fixing the display panel 16 onto the carrying device 2 by the fixing member 15;

at step S2, adjusting the first threshold to be about 45 KPa by the first threshold adjuster 4, and adjusting the cycle time to be about 3 seconds by the duration adjuster 5;

at step S3, selecting a detection point on the display panel 16, using one end of the suction pipe 8 to contact and conduct vacuum suction to the detection point on the display panel 16, the suction pressure is about 45 KPa, and the duration time is about 3 seconds;

at step S4, lighting on the display panel 16 during the vacuum suction, and observing display evenness at the detection point on the display panel 16; and

at step S5, repeating steps S3 and S4 at other detection points to detect the other detection points after the detection at the detection point on the display panel 16 is finished.

If the display screen at each detection point of the display panel 16 is even, it can be determined that the display panel 16 does not have any gravity Mura defect.

In the exemplary embodiment according to the disclosure, the first threshold may be in a range of about 42 to 48 KPa so as to realize good vacuum suction. Obviously, the first threshold is not limited to this range, but may be set to be any suitable value according to actual applications.

In the exemplary embodiment according to the disclosure, the cycle time may be in a range of about 1 to 5 seconds so that the display evenness at the detection point may be thoroughly detected within the cycle time. Obviously, the cycle time is not limited to this range, but may be set to be any suitable value according to actual applications.

It should be understood that the above embodiments are merely exemplary embodiments for the purpose of illustrating the principle of the disclosure, and the disclosure is not limited thereto. Various modifications and improvements can be made by a person having ordinary skill in the art without departing from the spirit and essence of the disclosure. Accordingly, all of the modifications and improvements also fall into the protection scope of the disclosure.

1-13. (canceled)

14. A suction apparatus comprising:
a vacuum pump;
a suction pipe connected to the vacuum pump at one end;
a pressure detecting device disposed on the suction pipe and configured to detect a pressure value within the suction pipe;
a controller with a first threshold that receives the pressure value detected by the pressure detecting device and controls the vacuum pump according to a result obtained by comparing the pressure value with the first threshold; and
a housing within which the vacuum pump, the controller and the pressure detecting device are located.

15. The suction apparatus according to claim 14, further comprising:
a first threshold adjuster provided on the housing and connected to the controller to adjust the first threshold.

16. The suction apparatus according to claim 14,
wherein the controller maintains the pressure value within the suction pipe at the first threshold for a cycle time from the vacuum pump is shut down.

17. The suction apparatus according to claim 16, further comprising:
a duration adjuster provided on the housing and connected to the controller to adjust the cycle time.

18. The suction apparatus according to claim 16, further comprising:
a display device disposed on the housing and configured to display a remaining time that indicates a duration time to maintain the pressure value within the suction pipe at the first threshold.

19. The suction apparatus according to claim 16, further comprising:
an alarm device provided on the housing and connected to the controller to alarm when the controller determines that the pressure value is greater than the first threshold within the cycle time.

20. The suction apparatus according to claim 16, further comprising:
an alarm device provided on the housing and connected to the controller to alarm when the controller determines that the pressure value is smaller than the first threshold within the cycle time.

21. The suction apparatus according to claim 14,
wherein the first threshold is in a range of about 42 to 48 KPa.

22. The suction apparatus according to claim 16,
wherein the cycle time is in a range of about 1 to 5 seconds.

23. The suction apparatus according to claim 14,
wherein the suction pipe has a diameter of about 6 to 10 mm.

24. The suction apparatus according to claim 14,
wherein the vacuum pump is a micro air pump.

25. A detecting system comprising the suction apparatus according to claim 14.

26. The detecting system according to claim 25, further comprising:
a carrying device configured to carry a display panel, wherein the suction pipe contacts the display panel at the other end so that the suction apparatus sucks the display panel.

27. The detecting system according to claim 26,
wherein the carrying device includes a fixing device configured to fix the display panel onto the carrying device.
